(19) United States
(12) Patent Application Publication
(10) Pub. No.: US 2024/0276472 A1
(43) Pub. Date: Aug. 15, 2024

(54) METHOD FOR RESOURCE INDICATION, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Yi ZHANG, Dongguan (CN)

(21) Appl. No.: 18/642,758

(22) Filed: Apr. 22, 2024

Related U.S. Application Data
(63) Continuation of application No. PCT/CN2021/126738, filed on Oct. 27, 2021.

(51) Int. Cl. H04W 72/0453; H04W 72/0446

(52) U.S. Cl. CPC H04W 72/0453; H04W 72/0446

(57) ABSTRACT

A method for resource indication, a terminal device, a network device, a chip, a computer-readable storage medium, a computer program product, a computer program, and a communication system are provided. The method includes the following. A terminal device receives first indication information sent by a network device, where the first indication information indicates at least one first frequency-domain resource unit scheduled for or allocated to the terminal device; the at least one first frequency-domain resource unit belongs to a first frequency-domain resource unit group, and the first frequency-domain resource unit group is in an active bandwidth part (BWP) of the terminal device.

### CROSS-REFERENCE TO RELATED APPLICATION(S)

This application is a continuation of International Application No. PCT/CN2021/126738, filed Oct. 27, 2021, the entire disclosure of which is incorporated herein by reference.

### TECHNICAL FIELD

The disclosure relates to the field of communication, and more particularly, to a method for resource indication, a terminal device, a network device, a chip, a computer-readable storage medium, a computer program product, a computer program, and a communication system.

### BACKGROUND

In a new radio (NR) system, time division duplexing (TDD) configuration is very flexible. Specifically, the NR system adopts a flexible slot structure, that is, a slot may include a downlink (DL) symbol, a flexible symbol, and an uplink (UL) symbol. A symbol direction of the flexible symbol is unspecified and the flexible symbol may be modified into a DL symbol or an UL symbol via other signaling. In addition, in NR, multiple flexible slot structures are defined, and various slot structure configuration modes, such as semi-static UL/DL configuration and dynamic UL/DL configuration, can be supported. With regard to frequency-domain resource configuration, a resource allocation mode which can avoid redundancy in indication is required.

### SUMMARY

Embodiments of the disclosure provide a method for resource indication. The method includes the following. A terminal device receives first indication information sent by a network device, where the first indication information indicates at least one first frequency-domain resource unit scheduled for or allocated to the terminal device; the at least one first frequency-domain resource unit belongs to a first frequency-domain resource unit group, and the first frequency-domain resource unit group is in an active bandwidth part (BWP) of the terminal device.

Embodiments of the disclosure provide a network device. The network device includes a transceiver, a processor and a memory. The memory is configured to store computer programs. The processor is configured to invoke and execute the computer programs stored in the memory, to cause the transceiver to send first indication information to a terminal device, where the first indication information indicates at least one first frequency-domain resource unit scheduled for or allocated to the terminal device; the at least one first frequency-domain resource unit belongs to a first frequency-domain resource unit group, and the first frequency-domain resource unit group is in an active BWP of the terminal device.

Embodiments of the disclosure further provide a terminal device. The terminal device includes a transceiver, a processor and a memory. The memory is configured to store computer programs. The processor is configured to invoke and execute the computer programs stored in the memory, to cause the transceiver to receive first indication information sent by a network device, where the first indication information indicates at least one first frequency-domain resource unit scheduled for or allocated to the terminal device; the at least one first frequency-domain resource unit belongs to a first frequency-domain resource unit group, and the first frequency-domain resource unit group is in an active BWP of the terminal device.

### BRIEF DESCRIPTION OF THE DRAWINGS

FIG. 1 is a schematic architectural diagram of a wireless communication system according to embodiments of the disclosure.

FIG. 2 is a schematic diagram illustrating a slot structure according to embodiments of the disclosure.

FIG. 3 is a schematic diagram illustrating delay of flexible time division duplexing (TDD) according to embodiments of the disclosure.

FIG. 4A is schematic diagram I illustrating full duplex according to embodiments of the disclosure.

FIG. 4B is schematic diagram II illustrating full duplex according to embodiments of the disclosure.

FIG. 4C is schematic diagram III illustrating full duplex according to embodiments of the disclosure.

FIG. 5 is a schematic diagram illustrating frequency-domain resource allocation according to embodiments of the disclosure.

FIG. 6 is a schematic flowchart of a method for resource indication provided in an embodiment of the disclosure.

FIG. 7 is a schematic flowchart of a method for resource indication provided in another embodiment of the disclosure.

FIG. 8 is a schematic diagram illustrating a first frequency-domain resource unit group according to an embodiment of the disclosure.

FIG. 9 is a schematic diagram illustrating a first frequency-domain resource unit group according to another embodiment of the disclosure.

FIG. 10 is a schematic structural block diagram of a terminal device provided in an embodiment of the disclosure.

FIG. 11 is a schematic structural block diagram of a terminal device provided in another embodiment of the disclosure.

FIG. 12 is a schematic structural block diagram of a network device provided in an embodiment of the disclosure.

FIG. 13 is a schematic structural block diagram of a network device provided in another embodiment of the disclosure.

FIG. 14 is a schematic block diagram of a communication device according to embodiments of the disclosure.

FIG. 15 is a schematic block diagram of a chip according to embodiments of the disclosure.

FIG. 16 is a schematic block diagram of a communication system according to embodiments of the disclosure.

### DETAILED DESCRIPTION

Technical solutions of embodiments of the disclosure will be described below with reference to the accompanying drawings in the embodiments of the disclosure.

The technical solutions of embodiments of the disclosure are applicable to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (WiFi), a 5th-generation (5G) communication system, or other communication systems, etc.

Generally speaking, a conventional communication system generally supports a limited quantity of connections and therefore is easy to implement. However, with development of communication technology, a mobile communication system will not only support conventional communication but also support, for example, device to device (D2D) communication, machine to machine (M2M) communication, machine type communication (MTC), vehicle to vehicle (V2V) communication, or vehicle to everything (V2X) communication, etc. Embodiments of the disclosure can also be applied to these communication systems.

Optionally, the communication system in embodiments of the disclosure may be applied to a carrier aggregation (CA) scenario, or may be applied to a dual connectivity (DC) scenario, or may be applied to a standalone (SA) network deployment scenario.

Various embodiments of the disclosure are described in connection with a network device and a terminal device. The terminal device may also be referred to as a user equipment (UE), an access terminal, a subscriber unit, a subscriber station, a mobile station, a remote station, a remote terminal, a mobile device, a user terminal, a terminal, a wireless communication device, a user agent, or a user device, etc.

The terminal device may be a station (ST) in a WLAN, a cellular radio telephone, a cordless telephone, a session initiation protocol (SIP) telephone, a wireless local loop (WLL) station, a personal digital assistant (PDA), a handheld device or a computing device with wireless communication functions, other processing devices coupled with a wireless modem, an in-vehicle device, a wearable device, and a terminal device in a next-generation communication system, for example, a terminal device in an NR network, or a terminal device in a future evolved public land mobile network (PLMN), etc.

In embodiments of the disclosure, the terminal device may be deployed on land, which includes indoor or outdoor, handheld, wearable, or in-vehicle. The terminal device may also be deployed on water (such as ships, etc.). The terminal device may also be deployed in the air (such as airplanes, balloons, satellites, etc.).

In embodiments of the disclosure, the terminal device may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medicine, a wireless terminal device in smart grid, a wireless terminal device in transportation safety, a wireless terminal device in smart city, or a wireless terminal device in smart home, etc.

By way of explanation rather than limitation, in embodiments of the disclosure, the terminal device may also be a wearable device. The wearable device may also be called a wearable smart device, which is a generic term of wearable devices obtained through intelligentization design and development on daily wearing products with wearable technology, for example, glasses, gloves, watches, clothes, accessories, and shoes. The wearable device is a portable device that can be directly worn or integrated into clothes or accessories of a user. In addition to being a hardware device, the wearable device can also realize various functions through software support, data interaction, and cloud interaction. A wearable smart device in a broad sense includes, for example, a smart watch or smart glasses with complete functions and large sizes and capable of realizing independently all or some of functions of a smart phone, and for example, various types of smart bands and smart jewelries for physical monitoring, of which each is dedicated to application functions of a certain type and required to be used together with other devices such as a smart phone.

In embodiments of the disclosure, the network device may be a device configured to communicate with a mobile device, and the network device may be an access point (AP) in a WLAN, a base transceiver station (BTS) in GSM or CDMA, or may be a Node B (NB) in WCDMA, or may be an evolutional Node B (eNB or eNodeB) in LTE, or a relay station or AP, or an in-vehicle device, a wearable device, a network device (gNB) in an NR network, or a network device in a future evolved PLMN, etc.

By way of explanation rather than limitation, in embodiments of the disclosure, the network device may be mobile. For example, the network device may be a mobile device. Optionally, the network device may be a satellite or a balloon base station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station deployed on land or water.

In embodiments of the disclosure, the network device serves a cell, and the terminal device communicates with the network device on a transmission resource (for example, a frequency-domain resource or a spectrum resource) for the cell. The cell may be a cell corresponding to the network device (for example, a base station). The cell may belong to a macro base station, or may belong to a base station corresponding to a small cell. The small cell may include: a metro cell, a micro cell, a pico cell, a femto cell, and the like. These small cells are characterized by small coverage and low transmission power and are adapted to provide data transmission service with high-rate.

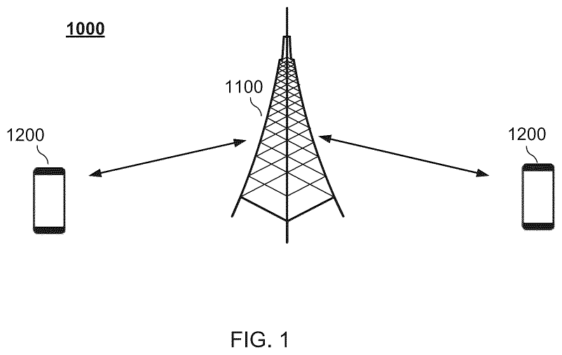

FIG. 1 is a diagram of a wireless communication system 1000 that includes one network device 1100 and two terminal devices 1200. Optionally, the wireless communication system 1000 may include multiple network devices 1100, and there may be other quantities of terminal devices in a coverage area of each of the network devices 1100, and embodiments of the disclosure are not limited in this regard. Optionally, the wireless communication system 1000 illustrated in FIG. 1 may further include other network entities such as a mobility management entity (MME), an access and mobility management function (AMF), etc., and embodiments of the disclosure are not limited in this regard.

It should be understood that, in embodiments of the disclosure, a device with communication functions in a network/system can be referred to as a “communication device”. Taking the communication system illustrated in FIG. 1 as an example, the communication device may include the network device and the terminal device(s) that have communication functions. The network device and the terminal device(s) may be the devices described above and will not be elaborated again herein. The communication device may further include other devices such as a network controller, an MME, or other network entities in the communication system, and embodiments of the disclosure are not limited in this regard.

It should be understood that, the terms “system” and “network” herein are usually used interchangeably throughout this disclosure. The term “and/or” herein only describes an association between associated objects, which means that there can be three relationships. For example, A and/or B can mean A alone, both A and B exist, and B alone. In addition, the character “/” herein generally indicates that the associated objects are in an “or” relationship.

It should be understood that, “indication” referred to in embodiments of the disclosure may be a direct indication, may be an indirect indication, or may mean that there is an association. For example, A indicates B may mean that A directly indicates B, for instance, B can be obtained according to A; may mean that A indirectly indicates B, for instance, A indicates C, and B can be obtained according to C; or may mean that that there is an association between A and B.

In the elaboration of embodiments of the disclosure, the term “correspondence” may mean that there is a direct or indirect correspondence between the two, may mean that there is an association between the two, or may mean a relationship of indicating and indicated or configuring and configured, etc.

In order to facilitate understanding of the technical solutions of embodiments of the disclosure, the following will describe the related art of embodiments of the disclosure. The following related art as an optional solution may be arbitrarily combined with the technical solutions of embodiments of the disclosure, which shall all belong to the protection scope of embodiments of the disclosure.

### (I) Flexible Time Division Duplexing (TDD)

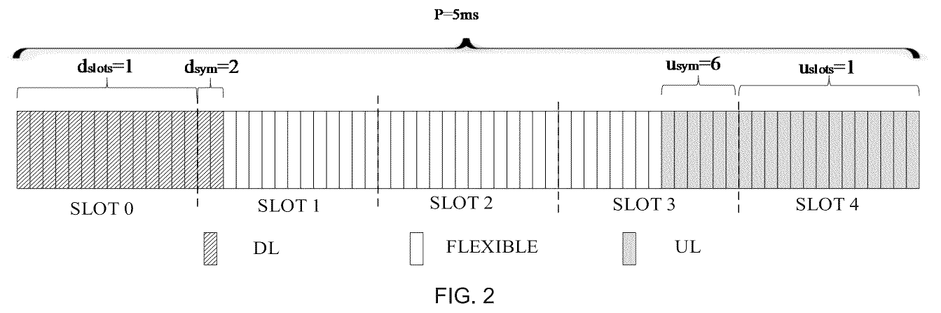

An NR system adopts a flexible slot structure, that is, a slot may include a downlink (DL) symbol, a flexible symbol, and an uplink (UL) symbol. A symbol direction of the flexible symbol is unspecified, and the flexible symbol may be modified into a DL symbol or an UL symbol via other signaling. In addition, in NR, multiple flexible slot structures are defined, including a full DL slot, a full UL slot, and a full flexible slot as well as slot structures with different numbers (that is, quantities) of DL symbols, UL symbols, and flexible symbols; and two configuration modes, namely semi-static UL/DL configuration and dynamic UL/DL configuration, are supported.
1. Semi-static UL/DL configuration information includes tdd-UL-DL-ConfigurationCommon and tdd-UL-DL-ConfigurationDedicated, where the former is a cell-specific slot structure configuration, and the latter is a UE-specific slot structure configuration. A configuration parameter includes: a reference subcarrier spacing μ_{ref}, a period P, the number dₛₗₒₜₛ of DL slots, the number d_{sym} of DL symbols, the number uₛₗₒₜₛ of UL slots, and the number u_{sym} of UL symbols. The total number S of slots in a period may be determined according to the reference subcarrier spacing and the period P. As illustrated in FIG. 2, the first dₛₗₒₜₛ slots in the S slots are full DL slots, and the first d_{sym} symbols in the next slot of the last full DL slot are DL symbols. The last uₛₗₒₜₛ slots in the S slots are full UL slots, and the last u_{sym} symbols in the previous slot of the 1^{st} full UL slot are UL symbols. The remaining symbols in the period are flexible symbols.
2. Dynamic UL/DL configuration information includes a slot format indicator (SFI) which can dynamically indicate a slot format of each slot. The dynamic SFI can only be used for configuring a direction of a flexible symbol (namely, the symbols illustrated as blank (flexible symbols) in FIG. 2) configured by the semi-static UL/DL configuration information, but cannot modify a direction of an UL symbol or a DL symbol configured by the semi-static UL/DL configuration information.

### (II) Full Duplex

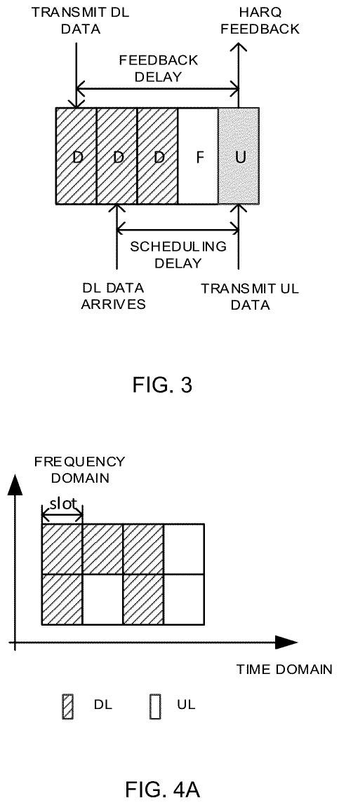

Flexible TDD has advantages of dynamic adaptation to UL/DL services of a network, reduced delay, and good forward compatibility. However, although an UL/DL direction of a slot/symbol in flexible TDD is flexible, once the symbol/slot is indicated as UL or DL, due to a half-duplex operating mode of a base station/terminal, only a transmit/receive operation can be performed on a DL symbol and only a receive/transmit operation can be performed on an UL symbol, that is, transmission and reception cannot be performed simultaneously. In addition, since a percentage of DL services is usually greater than that of UL services due to asymmetry of services in a system, a DL slot/symbol often occupies a large proportion in a frame structure indicated by dynamic TDD UL/DL configuration/indication, for example, a frame structure like “DDDSU”, which may cause the following problems.
1. UL coverage is restricted due to fewer UL resources.
2. Delay of UL feedback/UL scheduling is increased due to fewer UL resources. As illustrated in FIG. 3, if there is an UL hybrid automatic repeat reQuest (HARQ) acknowledgement (HARQ-ACK) feedback or there is an UL data packet that is to be scheduled, it is necessary to wait until there is an UL slot/symbol in order for transmission.
3. Because time is divided for UL and DL, efficiency in spectrum utilization is low. For example, for all frequency-domain resources in a DL symbol, even if a DL data packet occupies only some of the frequency-domain resources in the symbol, the remaining frequency-domain resources cannot be used for transmitting an UL data packet.

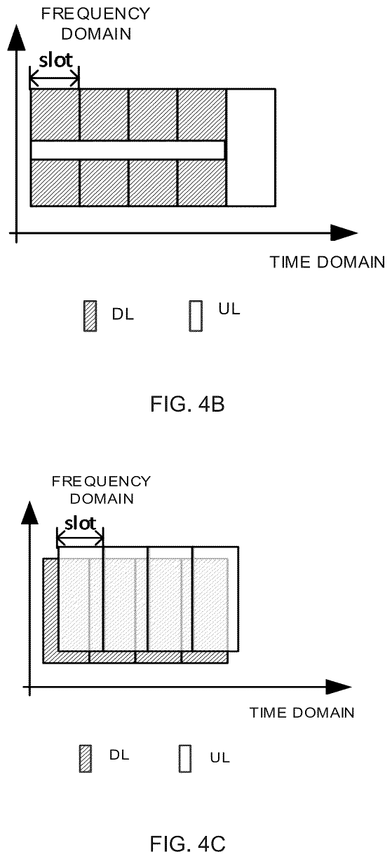

Based on the above problems caused by flexible TDD/half-duplex, the concept of full duplex is proposed in the related art, which includes various operating modes such as base station full-duplex+terminal half-duplex, base station full-duplex+terminal full-duplex, etc. As illustrated in FIG. 4A to FIG. 4C, in full duplex, reception and transmission can be performed simultaneously at a base station side or a UE side.

### (III) Frequency-Domain Resource Allocation

NR UL and DL each support two frequency-domain resource allocation types, namely frequency-domain resource allocation type 0 and frequency-domain resource allocation type 1.

### 1. Frequency-Domain Resource Allocation Type 0

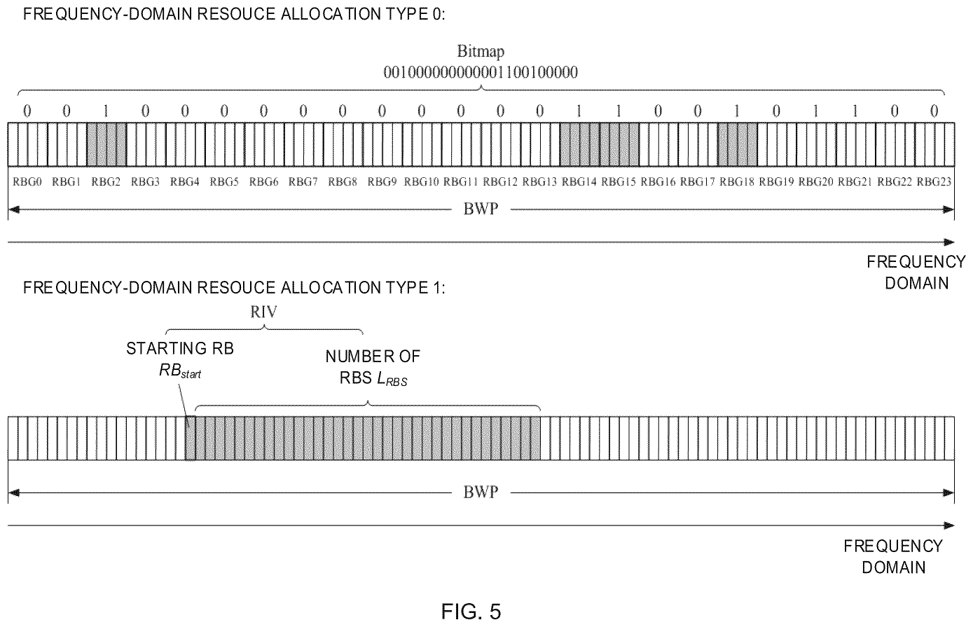

As illustrated in FIG. 5, a granularity for frequency-domain resource allocation type 0 is a resource block group(s) (RBG). The RBG is a set of RBs, and the number of RBs in each RBG is determined according to a size of a bandwidth part (BWP) and a radio resource control (RRC) configuration. In frequency-domain resource allocation type 0, a bitmap is adopted to indicate an RBG that is allocated to a terminal. If a value of a bit in the bitmap is “1”, it indicates that an RBG corresponding to the bit is allocated to the terminal; and if the value is “0”, it means that that the RBG corresponding to the bit is not allocated to the terminal. As such, it is possible to realize flexible distribution of frequency-domain resources in a BWP, support non-contiguous resource allocation, and counter frequency selective fading with aid of discrete frequency-domain transmission. However, such type has the following disadvantages: (1) the number of bits in a bitmap is large because all RBGs in a whole BWP need to be covered; (2) the granularity for resource allocation is coarse, because an RBG includes 2 to 16 RBs and resource selection cannot be performed per RB.

### 2. Frequency-Domain Resource Allocation Type 1

As illustrated in FIG. 5, in type 1, a resource indicator value (RIV) is adopted for joint encoding on a starting RB (RBstart) and the number of RBs (LRBs) allocated (the manner for calculating the RIV based on RBstart and LRBs will not be elaborated herein). The advantage of type 1 is that it is possible to use a smaller number of bits to indicate RB-level resources. However, the disadvantage is that only consecutive frequency-domain resources can be allocated, and if there are fewer resources, it will result in limited frequency diversity and vulnerability to influence of frequency selective fading.

However, no matter whether it is frequency-domain resource allocation type 0 or frequency-domain resource allocation type 1 described above, resources in a whole BWP need to be covered, which is well matched with flexible TDD and a half-duplex operating mode. Once a symbol is indicated as UL/DL, RBs in the symbol and in a BWP are all UL/DL resources, and it is impossible that different frequency-domain resources in the symbol and in the BWP have different UL/DL directions, and therefore, resources in the whole BWP should all be covered in frequency-domain resource allocation. However, after the concept/operating mode of full duplex is proposed, if frequency-domain resources in the whole BWP are still all covered in frequency-domain resource allocation type 0/type 1, it will result in redundancy in indication. Taking UL resource allocation as an example, in the full-duplex operating mode in each of FIG. 4A and FIG. 4B, assuming that the whole BWP includes 36 RBs (RB 0˜RB 35) and each RBG includes two RBs, if the whole BWP is covered in frequency-domain resource allocation type 0, 18 bits will be required. However, in 1^{st} to 4^{th} slots in FIG. 4B, UL resources do not occupy the whole BWP, and instead, occupy only RBs in the middle of the BWP (assume that there are 8 RBs in the middle). Accordingly, among the 18 bits, except that the 4 bits in the middle may be set to “1”, the remaining 14 bits are all “0”, that is, the remaining 14 bits are wasted and are actually not in use for resource indication, thus causing redundancy in indication. Regarding frequency-domain resource allocation type 1, the similar problem also exists.

The solutions provided in embodiments of the disclosure are mainly intended for solving at least one of the problems described above. To this end, embodiments of the disclosure provide a method for resource indication, a terminal device, a network device, a chip, a computer-readable storage medium, a computer program product, a computer program, and a communication system, which is conducive for a network device to indicate a frequency-domain resource to a terminal device.

In order for better understanding of the features and technical content of the embodiments of the disclosure, the following will describe in detail the implementation of the embodiments of the disclosure with reference to the accompanying drawings. The accompanying drawings are only intended for illustration, rather than limitation on the embodiments of the disclosure.

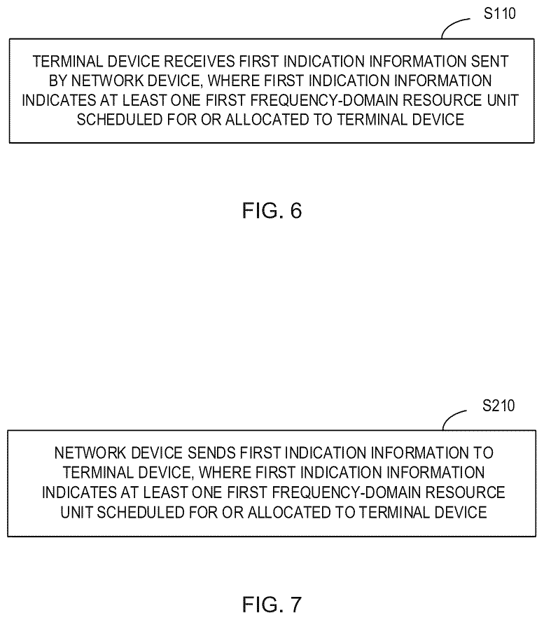

FIG. 6 is a schematic flowchart of a method for resource indication according to an embodiment of the disclosure. The method may optionally be applied to the terminal device in the system illustrated in FIG. 1, but is not limited thereto. The method includes the following.
S110, a terminal device receives first indication information sent by a network device, where the first indication information indicates at least one first frequency-domain resource unit scheduled for or allocated to the terminal device.

The at least one first frequency-domain resource unit belongs to a first frequency-domain resource unit group, and the first frequency-domain resource unit group is in an active BWP of the terminal device.

Accordingly, the terminal device may determine, according to the first indication information, the at least one first frequency-domain resource unit scheduled for or allocated to the terminal device by the network device from the first frequency-domain resource unit group.

According to technical solutions of embodiments of the disclosure, the network device indicates to the terminal device the first frequency-domain resource unit scheduled for or allocated to the terminal device. The first frequency-domain resource unit belongs to the first frequency-domain resource unit group, and the first frequency-domain resource unit group is in the active BWP, that is, the first frequency-domain resource unit group is a subset of the active BWP. Compared with indication based on resources in the whole BWP, it is possible to avoid redundancy in indication, thereby reducing indication overhead and/or improving spectrum utilization.

In addition, the terminal device may perform data transmission over the at least one first frequency-domain resource unit described above. For example, if the at least one first frequency-domain resource unit scheduled for or allocated to the terminal device by the network device is an UL resource(s), the terminal device selects a resource from the at least one first frequency-domain resource unit for data transmission. For another example, if the at least one first frequency-domain resource unit scheduled for or allocated to the terminal device by the network device is a DL resource(s), the terminal device selects a resource from the at least one first frequency-domain resource unit for data reception.

Optionally, in embodiments of the disclosure, the first frequency-domain resource unit group is in the active BWP of the terminal device. In practice, a size of the first frequency-domain resource unit group may be smaller than a size of the active BWP.

According to the foregoing method, the first frequency-domain resource unit indicated to be scheduled for or allocated to the terminal device by the network device belongs to the first frequency-domain resource unit group, and the first frequency-domain resource unit group is in the active BWP, in other words, the first frequency-domain resource unit group is a subset of the active BWP. Compared with indication based on resources in the whole BWP, it is possible to avoid redundancy in indication, which is beneficial to reducing indication overhead or improving spectrum utilization.

Correspondingly, another embodiment of the disclosure provides a method for resource indication. FIG. 7 is a schematic flowchart illustrating the method. The method may optionally be applied to the network device in the system illustrated in FIG. 1, but is not limited thereto. The method includes the following.
S210, a network device sends first indication information to a terminal device, where the first indication information indicates at least one first frequency-domain resource unit scheduled for or allocated to the terminal device.

The at least one first frequency-domain resource unit belongs to a first frequency-domain resource unit group, and the first frequency-domain resource unit group is in an active BWP of the terminal device.

In embodiments of the disclosure, the active BWP is a BWP configured for the terminal device by the network device after initial access is completed. Exemplarily, the active BWP includes a BWP indicated by a bandwidth part indicator field in downlink control information (DCI) sent by the network device, that is, a BWP after switching indicated by the network device.

Optionally, the first frequency-domain resource unit group may include at least one first frequency-domain resource unit. The first frequency-domain resource unit may be a resource element (RE), an RB, an RBG, or a subband, etc. It should be noted that, a resource unit in embodiments of the disclosure does not specifically refer to an RE. For example, a frequency-domain resource unit may refer to an RE, an RB, an RBG, a subband, etc., and a time-domain resource unit may refer to a frame, a subframe, a slot, a subslot, a symbol, a second, a millisecond, etc.

Optionally, the first frequency-domain resource unit group may include several frequency-domain resources of the same resource type. The resource type of a resource indicates a transmission direction of the resource, such as UL, DL, flexible, non-UL, and non-DL. A resources of which the resource type is non-UL may include a DL resource and/or a flexible resource, and a resource of which the resource type is non-DL may include an UL resource and/or a flexible resource. Here, the flexible resource may refer to a frequency-domain resource that can be further configured as UL or DL.

Exemplarily, the first frequency-domain resource unit group may include at least one DL resource, for example, at least one first frequency-domain resource unit used for DL, that is, the first frequency-domain resource unit group is a DL resource group. Alternatively, the first frequency-domain resource unit group may include at least one UL resource, for example, at least one first frequency-domain resource unit used for UL, that is, the first frequency-domain resource unit group is an UL resource group.

Exemplarily, if the resource type may be non-UL or non-DL (that is, a DL resource and a flexible resource are considered to be of the same resource type and are both non-UL, and an UL resource and a flexible resource are considered to be of the same resource type and are both non-DL), the first frequency-domain resource unit group may include at least one DL resource and at least one flexible resource, that is, the first frequency-domain resource unit group is a non-UL resource group; alternatively, the first frequency-domain resource unit group may include at least one UL resource and at least one flexible resource, that is, the first frequency-domain resource unit group is a non-DL resource group.

Optionally, if the resource type may be UL, DL, or flexible (that is, a DL resource and a flexible resource are considered to be of different resource types, and an UL resource and a flexible resource are considered to be of different resource types), the first frequency-domain resource unit group may include a flexible resource(s) and several frequency-domain resources of the same resource type. For example, the first frequency-domain resource unit group is a non-UL resource group (DL resource group+flexible resource group), and may include at least one DL resource (for example, at least one first frequency-domain resource unit used for DL) and at least one flexible resource. For another example, the first frequency-domain resource unit group is a non-DL resource group (UL resource group+flexible resource group), and may include at least one UL resource (for example, at least one first frequency-domain resource unit used for UL) and at least one flexible resource.

As can be seen, the first frequency-domain resource unit group may be a DL resource group, an UL resource group, a non-DL resource group, or a non-UL resource group. In other words, a resource type of the first frequency-domain resource unit group may be DL, UL, non-DL, or non-UL.

Optionally, the resource type of the first frequency-domain resource unit group and/or the first frequency-domain resource unit group is determined based on second indication information sent by the network device. That is, the network device may send the second indication information to the terminal device, and accordingly, the terminal device receives the second indication information sent by the network device, where the second indication information may indicate the resource type of the first frequency-domain resource unit group and/or the first frequency-domain resource unit group.

Exemplarily, the second indication information may indicate the first frequency-domain resource unit group. The first frequency-domain resource unit group is exemplarily an UL resource group, and the second indication information may indicate a frequency-domain resource(s) of which the resource type is UL. As such, the terminal device may determine an UL resource group, and then determine, according to the first indication information, at least one UL resource allocated or scheduled by the network device from the UL resource group.

Exemplarily, the second indication information may indicate resource types of frequency-domain resources (including the first frequency-domain resource unit group) in a BWP. The first frequency-domain resource unit group is exemplarily an UL resource group, and the second indication information indicates the resource types of the frequency-domain resources in the BWP. As such, the terminal device may determine an UL resource(s) from the frequency-domain resources to obtain an UL resource group, and then determine, according to the first indication information, at least one UL resource allocated or scheduled by the network device from the UL resource group.

Optionally, the second indication information is carried in higher layer configuration signaling or DCI. Exemplarily, the higher layer configuration signaling may include a system information block (SIB), RRC signaling, or a media access control-control element (MAC CE), etc.

In some embodiments, the first frequency-domain resource unit group may be a set of frequency-domain resource units in a specific time-domain resource. It should be noted that, in embodiments of the disclosure, a frequency-domain resource unit in a time-domain resource may also be understood as a frequency-domain resource unit within a time-domain resource or a frequency-domain resource unit corresponding to a time-domain resource. The terminal device needs to determine the first frequency-domain resource unit group according to information of the time-domain resource. Accordingly, the second indication information may indicate, in various manners, the resource type of the first frequency-domain resource unit group or the first frequency-domain resource unit group in the specific time-domain resource.

Example 1: the second indication information indicates a resource type of a frequency-domain resource unit in a first time-domain resource. In other words, the second indication information indicates that a frequency-domain resource in the first time-domain resource is an UL resource, a DL resource, or a flexible resource. Optionally, in some embodiments, the second indication information may also indicate that the frequency-domain resource in the first time-domain resource is a non-UL resource or a non-DL resource.

Accordingly, the method for resource indication further includes the following. The terminal device determines the resource type of the first frequency-domain resource unit group in the first time-domain resource or the first frequency-domain resource unit group in the first time-domain resource according to a resource type of the first time-domain resource and/or the resource type of the frequency-domain resource unit in the first time-domain resource. Exemplarily, the network device may firstly indicate resource types of multiple time-domain resources, and then indicate, via the second indication information, the resource type of the frequency-domain resource unit in the first time-domain resource among the multiple time-domain resources. As such, according to the resource type of the first time-domain resource and the resource type of the frequency-domain resource unit in the first time-domain resource, the terminal device may determine a DL resource group and/or an UL resource group in the first time-domain resource, or determine a non-UL resource group and/or a non-DL resource group in the first time-domain resource.

Exemplarily, the second indication information may indicate a resource type of at least some frequency-domain resource unit(s) in the first time-domain resource. In this optional implementation, the terminal device may determine a resource type of each frequency-domain resource unit in the first time-domain resource according to the resource type of the first time-domain resource and the resource type of the frequency-domain resource unit indicated by the second indication information. For example, if the second indication information indicates a resource type of some frequency-domain resource unit in the first time-domain resource, the terminal device may determine the resource type of the frequency-domain resource unit according to the second indication information. If the second indication information does not indicate a resource type of some frequency-domain resource unit in the first time-domain resource, the terminal device may determine the resource type of the frequency-domain resource unit according to the resource type of the first time-domain resource (for example, if the first time-domain resource is an UL resource, the resource type of the frequency-domain resource unit is an UL resource). After determining the resource type of each frequency-domain resource unit, a DL resource group, an UL resource group, a non-UL resource group, or a non-DL resource group in the first time-domain resource can be determined.

Exemplarily, the second indication information may indicate resource types of all frequency-domain resource units in the first time-domain resource. The terminal device may determine a resource type of each frequency-domain resource unit in the first time-domain resource according to the second indication information, thereby determining a DL resource group, an UL resource group, a non-UL resource group, or a non-DL resource group in the first time-domain resource based on the resource type of each frequency-domain resource unit.

Optionally, the first time-domain resource includes at least one of: at least one symbol, at least one slot, at least one subslot, at least one UL/DL transmission period, at least one subframe, or at least one frame. For example, the first time-domain resource may be a symbol, a symbol group, a slot, a slot group, a subslot, a subslot group, an UL/DL period, a sub-frame, or a frame, etc. For another example, the first time-domain resource may be multiple symbols, multiple symbol groups, multiple slots, multiple slot groups, etc. The first time-domain resource may also be a combination of multiple symbols and multiple slots, a combination of multiple frames and multiple subframes, etc., and embodiments of the disclosure are not limited in this regard.

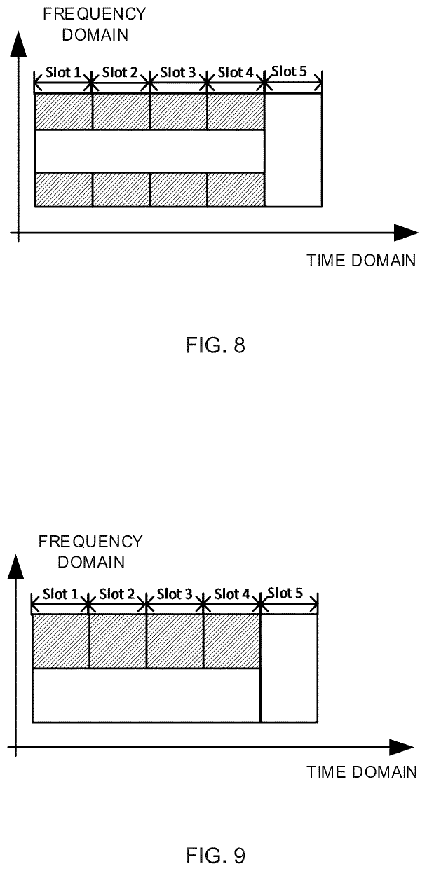

For example, as illustrated in FIG. 8, the network device configures five slots (slots 1˜5) as a “DDDDU” format in the flexible TDD indication mode described above (semi-static configuration and/or dynamic indication), that is, configures slots 1˜4 each as a DL slot and slot 5 as an UL slot. Then the network device configures/indicates, via the second indication information (semi-static configuration signaling/dynamic indication signaling), that frequency-domain resources in the middle in the frequency domain corresponding to slots 1˜4 are UL resources (indicated by the blank block in FIG. 8). In this case, the terminal device may determine, according to the slot format “DDDDU” and the second indication information, that the frequency-domain resources in the middle corresponding to slots 1˜4 are UL resources and frequency-domain resources above and below the middle in the frequency domain corresponding to slots 1˜4 are DL resources (indicated by shadow blocks in FIG. 8), and as such, the terminal device can determine an UL resource group and a DL resource group in slots 1˜4.

For example, a BWP may be divided into 3 frequency-domain resource groups, and the second indication information may be a bitmap, where the bitmap includes 3 bits and may indicate resource types (UL/DL directions) of the 3 frequency-domain resource groups in slots 1˜4. Assuming that the value “1” indicates UL and the value “0” indicates DL, then the bitmap may be “010”. For another example, the second indication information may indicate a 1^{st} frequency-domain resource unit used for UL in the BWP and the number of frequency-domain resource units used for UL in the BWP, or may indicate a 1^{st} frequency-domain resource unit used for DL and the number of frequency-domain resource units used for DL in the BWP.

In practice, the network device may also firstly indicate resource types of frequency-domain resources in a BWP, and then indicate, via the second indication information, a resource type of a time-domain resource unit in a first frequency-domain resource among the frequency-domain resources. As such, according to a resource type of the first frequency-domain resource and the resource type of the time-domain resource unit in the first frequency-domain resource, the terminal device may determine a DL resource group and/or an UL resource group, or a non-UL resource group and/or a non-DL resource group in the first frequency-domain resource. For the technical details thereof, reference can be made to the examples in Example 1, which will not be elaborated herein.

Example 2: the second indication information indicates a resource type(s) of M time-frequency resources, and each time-frequency resource in the M time-frequency resources is determined based on a time-domain resource unit and a frequency-domain resource unit corresponding to the time-frequency resource, where M is an integer and M≥1. That is, time-frequency resources can be divided based on two dimensions, namely time domain and frequency domain, and a time-frequency resource can be uniquely determined based on a time-domain location and a frequency-domain location. The second indication information directly indicates, by means of a time-frequency two-dimensional indication, that a time-frequency resource is an UL resource, a DL resource, or a flexible resource, that is, indicates directly a resource type of a time-frequency resource having time-frequency two-dimensional information.

Accordingly, the method for resource indication further includes the following. The terminal device obtains the first frequency-domain resource unit group or the resource type of the first frequency-domain resource unit group according to the resource type of the M time-frequency resource units.

The first frequency-domain resource unit group may be a set of frequency-domain resource units (DL resource group, UL resource group, non-DL resource group, or non-UL resource group) in a corresponding time-domain resource unit.

Optionally, the second indication information includes M pieces of bit information that are in one-to-one correspondence with the M time-frequency resources, and each bit information of the M pieces of bit information indicates a resource type of a time-frequency resource corresponding to the bit information. Each bit information may include one or more bits. For example, each bit information includes one bit, and in this case, the second indication information includes M bits, where for each bit, “0” or “1”, indicates that a time-frequency resource is UL or DL. For another example, each bit information includes a combination of two bits, and in this case, the second indication information includes M such combinations, where for each combination, “00”, “01”, or “10”, indicates that a time-frequency resource is UL, DL, or flexible respectively.

For example, as illustrated in FIG. 8, via the second indication information (semi-static configuration signaling/dynamic indication signaling), the network device indicates time-frequency two-dimensional resources as a distribution pattern illustrated in FIG. 8, that is, resources above and below the middle corresponding to slots 1˜4 are DL resources and resources in the middle corresponding to slots 1˜4 are UL resources, and resources corresponding to slot 5 are UL resources. The second indication information may be a bitmap. Time-frequency resources are divided at a predefined time-domain granularity and frequency-domain granularity, where the time-domain granularity may be a slot or a symbol, and the frequency-domain granularity may be an RB or an RBG. If the time-domain granularity is a slot and the frequency-domain granularity is an RBG, then as illustrated in FIG. 8, a BWP is divided into 3 RBGs, and a period is divided into 5 slots, thereby obtaining 3×5=15 time-frequency resources. The network device may adopt the second indication information including a 15-bit bitmap to indicate resource types (UL/DL directions) of the 15 time-frequency resources. For example, the bitmap may be that as shown below (“1” represents UL, and “0” represents DL):

| | | | | |
|---|---|---|---|---|
| 0 | 0 | 0 | 0 | 1 |
| 1 | 1 | 1 | 1 | 1 |
| 0 | 0 | 0 | 0 | 1 |

Taking slot 1 as an example, a bit corresponding to a time-frequency resource determined based on an RBG with the lowest frequency and slot 1 is “0”, a bit corresponding to a time-frequency resource determined based on an RBG with an intermediate frequency and slot 1 is “1”, and a bit corresponding to a time-frequency resource determined based on an RBG with the highest frequency and slot 1 is “0”, that is, the 3 RBGs in slot 1 are a DL resource, an UL resource, and a DL resource respectively. Therefore, a DL resource group in slot 1 includes the RBG with the lowest frequency and the RBG with the highest frequency, and an UL resource group in slot 1 includes the RBG with an intermediate frequency. Similarly, based on the bitmap, the terminal device can determine the first frequency-domain resource unit group (DL resource group, UL resource group, non-DL resource group, or non-UL resource group) in each slot.

In embodiments of the disclosure, via the first indication information, the network device indicates to the terminal device the first frequency-domain resource unit scheduled for or allocated to the terminal device. The first frequency-domain resource unit belongs to the first frequency-domain resource unit group, and the first frequency-domain resource unit group is in the active BWP, that is, the first frequency-domain resource unit group is a subset of the active BWP. Compared with indication based on resources in a whole BWP, redundancy in indication can be avoided. In practice, the first indication information may be set in various manners, thereby achieving different objectives in addition to avoiding redundancy in indication, for example, reducing indication overhead and/or improving spectrum utilization. Several examples will be given below.

Example 3: the first indication information includes N pieces of bit information, and each bit information in the N pieces of bit information corresponds to one first frequency-domain resource unit and indicates whether the first frequency-domain resource unit corresponding to the bit information is allocated to the terminal device, where Nis an integer and N≥1. Each bit information may include one or more bits.

For the convenience of illustration, each bit information exemplarily includes one bit. It can be understood that, for the case where each bit information includes multiple bits, the manner for configuring the first indication information is similar and will not be described in detail herein. Exemplarily, similar to frequency-domain resource allocation type 0 in the related art described above, the first indication information includes a bitmap, where the bitmap includes N bits, and each bit in the bitmap is in one-to-one correspondence with first frequency-domain resource units in the first frequency-domain resource unit group. If a value of a bit is “1”, it may indicate that a first frequency-domain resource unit corresponding to the bit is allocated to the terminal device; if the value of the bit is “0”, it may indicate that the first frequency-domain resource unit corresponding to the bit is not allocated to the terminal device. Alternatively, if the value of the bit is 0, it may indicate that the first frequency-domain resource unit corresponding to the bit is allocated to the terminal device; if the value of the bit is 1, it may indicate that the first frequency-domain resource unit corresponding to the bit is not allocated to the terminal device.

Optionally, the first indication information may be a frequency domain resource assignment field in DCI.

Optionally, N is determined based on at least one of: the number of PRBs in the first frequency-domain resource unit group, an index of a starting PRB of the first frequency-domain resource unit group, or a size of the first frequency-domain resource unit.

The number of PRBs in the first frequency-domain resource unit group may represent a size of the first frequency-domain resource unit group. Optionally, N is determined at least based on the size of the first frequency-domain resource unit group.

Optionally, N may be determined in the following manner:

$$\\ N = {N}^{{}_{} size} / P$$

N^{size} is the number of PRBs in the first frequency-domain resource unit group, and P is the size of the first frequency-domain resource unit.

Optionally, N may be determined in the following manner:

$$\\ N = ⌈ ( {N}^{{}_{} size} + ( {N}^{{}_{} start} mod P ) ) / P ⌉$$

N^{size} is the number of PRBs in the first frequency-domain resource unit group, N^{start} is the index of the starting PRB of the first frequency-domain resource unit group, P is the size of the first frequency-domain resource unit, and [x] represents a ceiling operation on x.

Optionally, the size of the first frequency-domain resource unit is determined based on the number of second frequency-domain resource units in the first frequency-domain resource unit. Optionally, the second frequency-domain resource unit is a resource unit with the same granularity or a finer granularity than the first frequency-domain resource unit. Exemplarily, the first frequency-domain resource unit may be an RB, an RBG, or a subband, and accordingly, the second frequency-domain resource unit may be an RE, an RB, or an RBG. Specifically, the first frequency-domain resource unit may be an RBG, and accordingly, the second frequency-domain resource unit may be an RB. The size of an RBG is determined based on the number of RBs in the RBG (for example, 1 RBG includes 4 RBs, and accordingly, the size of the RBG is P=4). Alternatively, the first frequency-domain resource unit may be a subband, and accordingly, the second frequency-domain resource unit may be an RB or an RBG. The size of a subband is determined based on an RB(s) or an RBG(s) in the subband. It can be understood that, the first frequency-domain resource unit and the second frequency-domain resource unit may also be other frequency-domain resource units and are not limited to the examples above.

The implementation of the first indication information in this example will be described below with reference to the accompanying drawings. Referring to FIG. 8, via the second indication information (semi-static signaling/dynamic indication), the network device configures/indicates UL/DL directions of time-frequency resources as a distribution pattern illustrated in FIG. 8. Assume that a BWP includes 72 PRBs (PRB 0˜PRB 71), where 24 PRBs in the middle corresponding to slots 1˜4 are UL resources, and 24+24 PRBs at two sides of the middle corresponding to slots 1˜4 are DL resources; a granularity for frequency-domain resource allocation is RBG (namely, the first frequency-domain resource unit is an RBG), and each RBG includes 4 PRBs (namely, the second frequency-domain resource unit is a PRB, and the size of the first frequency-domain resource unit is 4 PRBs, that is, P=4). In this case, regarding a DL resource group, 48/4=12 bits are needed for the frequency domain resource assignment field (namely, the first indication information) in the DCI; regarding an UL resource group, 24/4=6 bits are needed for the frequency domain resource assignment field in the DCI. If indication is implemented based on the whole BWP, 72/4=18 bits are needed for the frequency domain resource assignment field in the DCI no matter whether it is UL or DL.

As can be seen, with the implementation provided in this example, a reference frequency-domain resource range indicated by the first indication information for frequency-domain resource allocation is defined as the first frequency-domain resource unit group. In this way, it is possible to reduce the number of bits required for a frequency domain resource assignment field in DCI without increasing a granularity for frequency-domain resource allocation, thereby reducing DCI overhead and improving reliability of a physical downlink control channel (PDCCH).

Example 4: the first indication information includes N pieces of bit information, and each bit information in the N pieces of bit information corresponds to one first frequency-domain resource unit and indicates whether the first frequency-domain resource unit corresponding to the bit information is allocated to the terminal device, where Nis an integer and N≥1. For the setting of the bit information, reference can be made to Example 3, which will not be elaborated again herein.

Optionally, the first indication information may be a frequency domain resource assignment field in DCI.

Different from example 3, in this example, Nis determined at least based on the size of the active BWP, and the size of the active BWP is determined based on the number of PRBs in the active BWP. That is, N is not determined based on the size of the first frequency-domain resource unit group, and N may be determined in the manner of frequency-domain resource allocation type 0 in the related art described above, i.e. N is determined according to the size of the active BWP and a first higher layer parameter such as the size of an RBG (rbg-Size).

Optionally, N is related to the first frequency-domain resource unit group, for example, the size of each first frequency-domain resource unit (namely, a granularity indicated by the first indication information) in the first frequency-domain resource unit group may be determined based on N. That is, in this example, the number of bits of the first indication information is determined according to the size of the BWP. Although the indication overhead is not reduced compared with the related art, a granularity of a resource indicated can be changed by adopting the same indication overhead to indicate a resource in the first frequency-domain resource unit group, thereby realizing a finer granularity of frequency-domain resource indication. After receiving the first indication information, the terminal device may determine the granularity indicated by the first indication information, and then determine, according to the granularity, a frequency-domain resource indicated by the first indication information from the first frequency-domain resource unit group.

Optionally, the size of the first frequency-domain resource unit is determined based on at least one of: a size of the first frequency-domain resource unit group, the size of the active BWP, the first higher layer parameter, or N. The first higher layer parameter is, for example, the size of an RBG (rbg-Size), and specifically, may be the number of PRBs in the RBG. The size of the first frequency-domain resource unit group may be defined based on the number of PRBs in the first frequency-domain resource unit group, or may be defined based on the number of first frequency-domain resource units in the first frequency-domain resource unit group.

In an implementation, the size of the first frequency-domain resource unit is determined based on the size of the first frequency-domain resource unit group and N. Exemplarily, the size of the first frequency-domain resource unit may be a ratio of the size of the first frequency-domain resource unit group to N. For example, if the size of the first frequency-domain resource unit group is 30 PRBs and the first indication information includes 5 bits, the granularity indicated by the first indication information (that is, the size of the first frequency-domain resource unit) is 6 PRBs.

In another implementation, the size of the first frequency-domain resource unit is determined based on the size of the first frequency-domain resource unit group, the size of the active BWP, and the first higher layer parameter.

Exemplarily, a scaling factor (or a scaling relationship) may be determined based on the size of the first frequency-domain resource unit group and the size of the active BWP and is denoted as a first factor (or a first relationship), and then the size of the first frequency-domain resource unit is determined based on the first factor (or the first relationship) and the size of the RBG indicated by the first higher layer parameter. The first factor (or the first relationship) is a ratio of the size of the first frequency-domain resource unit group to the size of the active BWP. Exemplarily, the size of the first frequency-domain resource unit in this example (namely, the granularity indicated by the first indication information in this example) is obtained based on the ratio and the size of the RBG (namely, a granularity of frequency-domain resource indication in type 0 in the related art) indicated by the first higher layer parameter.

For example, via the second indication information (semi-static signaling/dynamic indication), the network device configures/indicates UL/DL directions of time-frequency resources as a distribution pattern illustrated in FIG. 9. Assume that a BWP includes 72 PRBs (PRB 0˜PRB 71), where 36 PRBs below in slots 1˜4 are UL, 36 PRBs above in slots 1˜4 are DL, and a whole BWP in slot 5 is UL. In case frequency-domain resource allocation type 0 in the related art described above is adopted (the granularity for allocation is RBG), assuming that each RBG includes 8 PRBs, then a bitmap in the frequency domain resource assignment field in the DCI includes [(72/8)] 9 bits in total. If the implementation in this example is adopted, the frequency domain resource assignment field in the DCI includes 9 bits, and the granularity for allocation (namely, the size of the first frequency-domain resource unit) is

$$\\ ⌈ ( 36 / 9 ⌉ = 4 PRBs or ⌈ \frac{8}{( 72 / 36 )} ⌉ = 4 PRBs .$$

That is, in the implementation of this example, under the premise that the number of bits is unchanged, the granularity of frequency-domain resource indication in type 0 is reduced to 4 PRBs from 8 PRBs, that is, a granularity of frequency-domain indication is reduced, which is conducive to improving resources utilization.

Example 5: the first indication information indicates an index of a 1^{st} first frequency-domain resource unit allocated to the terminal device and the number of first frequency-domain resource units.

Optionally, the first indication information may be a frequency domain resource assignment field in DCI.

Optionally, the first indication information includes an RIV.

Optionally, a value of the RIV is determined based on the number of first frequency-domain resource units in the first frequency-domain resource unit group. Exemplarily, the value of the RIV is obtained based on the number of first frequency-domain resource units in the first frequency-domain resource unit group and the index of the 1^{st} first frequency-domain resource unit allocated to the terminal device.

For example, the first frequency-domain resource unit is an RB, and the value of the RIV is obtained in the following manner:

$$\\ if ( {L}_{RBs} - 1 ) \leq ⌊ {N}_{RB} / 2 ⌋ , then RIV = {N}_{RB} ( {L}_{RBs} - 1 ) + {RB}_{start} ; else ,$$

$$\\ RIV = {N}_{RB} ( {N}_{RB} - {L}_{RBs} + 1 ) + ( {N}_{RB} - 1 - {RB}_{start} ) where$$

$$\\ {L}_{RBs} \geq 1 and shall not exceed {N}_{RB} - {RB}_{start} .$$

N_{RB} is the number of RBs in the first frequency-domain resource unit group, RBstart is an index of a starting RB (a 1^{st} RB) allocated to the terminal device, L_{RBs} is the number of RBs allocated to the terminal device, and └N_{RB}/2┘ represents a floor operation on N_{RB}/2.

Optionally, the number of bits of the RIV is determined based on the number of first frequency-domain resource units in the first frequency-domain resource unit group. Specifically, the number of the bits of the RIV is determined based on the number of first frequency-domain resource units in the first frequency-domain resource unit group and the manner for calculating the value of the RIV. For example, in the foregoing calculation manner, the number of bits of the RIV is ┌log₂(N_{RB}(N_{RB}+1)/2)┐.

For example, via the second indication information (semi-static signaling/dynamic indication), the network device configures/indicates UL/DL directions of time-frequency resources as a distribution pattern illustrated in FIG. 8. Assume that a BWP includes 72 PRBs (PRB 0˜PRB 71), where 24 PRBs in the middle in slots 1˜4 are UL resources, and a total of 48 PRBs (24+24 PRBs) at two sides of the middle in slots 1˜4 are DL resources. Taking UL as an example, in the implementation of this example, if indication is implemented based on the first frequency-domain resource unit group, ┌log₂(24(24+1)/2)┐=8 bits are needed for the frequency domain resource assignment field in the DCI. If indication is implemented based on the whole BWP, ┌log 2(72(72+1)/2)┐=12 bits are needed for the frequency domain resource assignment field in the DCI.

It should be noted that, since the implementation in this example supports only contiguous resource allocation, if the first frequency-domain resource unit group is a DL resource group, the first frequency-domain resource unit group may be the 24 PRBs above or below in slots 1˜4, which may be numbered PRBs 0˜23 for resource allocation; alternatively, the PRBs above and below in slots 1˜4 may be combined to constitute 48 PRBs, which may be numbered PRBs 0˜47 for resource allocation.

As can be seen, in the implementation provided in this example, a reference frequency-domain resource range indicated by the first indication information for frequency-domain resource allocation is defined as the first frequency-domain resource unit group, which can reduce the number of bits required for a frequency domain resource assignment field in DCI without increasing a granularity for frequency-domain resource allocation, thereby reducing DCI overhead and improving reliability of a PDCCH.

The settings and implementations of embodiments of the disclosure are described above from different perspectives with reference to multiple embodiments. With at least one embodiment described above, the network device indicates to the terminal device the first frequency-domain resource unit scheduled for or allocated to the terminal device. The first frequency-domain resource unit belongs to the first frequency-domain resource unit group, and the first frequency-domain resource unit group is in the active BWP, that is, the first frequency-domain resource unit group is a subset of the active BWP. Compared with indication based on resources in the whole BWP, redundancy in indication can be avoided, thereby reducing indication overhead and/or improving spectrum utilization.

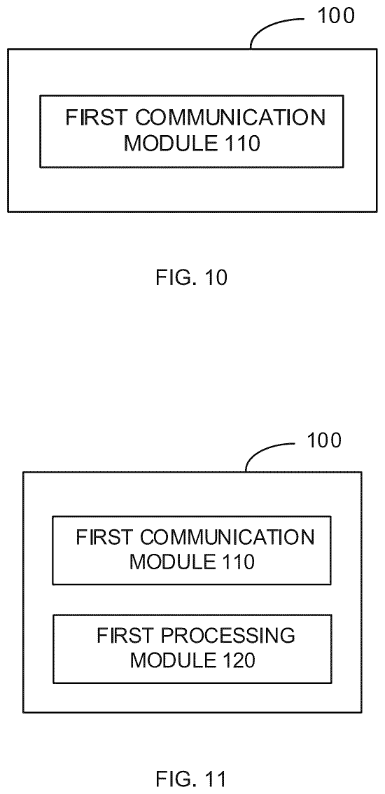

Corresponding to the method in at least one embodiment described above, embodiments of the disclosure further provides a terminal device 100. Referring to FIG. 10, the terminal device 100 includes a first communication module 110. The first communication module 110 is configured to receive first indication information sent by a network device, where the first indication information indicates at least one first frequency-domain resource unit scheduled for or allocated to the terminal device 100; the at least one first frequency-domain resource unit belongs to a first frequency-domain resource unit group, and the first frequency-domain resource unit group is in an active BWP of the terminal device 100.

Optionally, in embodiments of the disclosure, a resource type of the first frequency-domain resource unit group and/or the first frequency-domain resource unit group is determined based on second indication information sent by the network device.

Optionally, in embodiments of the disclosure, the second indication information is carried in higher layer configuration signaling or DCI.

Optionally, in embodiments of the disclosure, the second indication information indicates a resource type of a frequency-domain resource unit in a first time-domain resource. Accordingly, as illustrated in FIG. 11, the terminal device 100 further includes a first processing module 120. The first processing module 120 is configured to determine the resource type of the first frequency-domain resource unit group in the first time-domain resource or determine the first frequency-domain resource unit group in the first time-domain resource according to a resource type of the first time-domain resource and/or the resource type of the frequency-domain resource unit in the first time-domain resource.

Optionally, in embodiments of the disclosure, the first time-domain resource includes at least one of: at least one symbol, at least one slot, at least one subslot, at least one UL/DL transmission period, at least one subframe, or at least one frame.

Optionally, in embodiments of the disclosure, the second indication information indicates a resource type of M time-frequency resources, each time-frequency resource in the M time-frequency resources is determined based on a time-domain resource unit and a frequency-domain resource unit corresponding to the time-frequency resource, and M is an integer and M≥1. Accordingly, as illustrated in FIG. 11, the terminal device 100 further includes a first processing module 120. The first processing module 120 is configured to determine the resource type of the first frequency-domain resource unit group or determine the first frequency-domain resource unit group according to the resource type of the M time-frequency resources.

Optionally, in embodiments of the disclosure, the second indication information includes M pieces of bit information that are in one-to-one correspondence with the M time-frequency resources, and each bit information in the M pieces of bit information indicates a resource type of a time-frequency resource corresponding to the bit information.

Optionally, in embodiments of the disclosure, the first indication information includes N pieces of bit information, each bit information in the N pieces of bit information corresponds to one first frequency-domain resource unit and indicates whether the first frequency-domain resource unit corresponding to the bit information is allocated to the terminal device, and N is an integer and N≥1.

Optionally, in embodiments of the disclosure, Nis determined based on at least one of: the number of PRBs in the first frequency-domain resource unit group; an index of a starting PRB of the first frequency-domain resource unit group; or a size of the first frequency-domain resource unit.

Optionally, in embodiments of the disclosure, the size of the first frequency-domain resource unit is determined based on the number of second frequency-domain resource units in the first frequency-domain resource unit.

Optionally, in embodiments of the disclosure, the second frequency-domain resource unit is an RE, an RB, or an RBG.

Optionally, in embodiments of the disclosure, Nis determined at least based on a size of the active BWP, and the size of the active BWP is determined based on the number of PRBs in the active BWP.

Optionally, in embodiments of the disclosure, a size of the first frequency-domain resource unit is determined based on at least one of: a size of the first frequency-domain resource unit group, the size of the active BWP, a first higher layer parameter, or N.

Optionally, in embodiments of the disclosure, a size of the first frequency-domain resource unit is determined based on a size of the first frequency-domain resource unit group and N.

Optionally, in embodiments of the disclosure, a size of the first frequency-domain resource unit is determined based on a size of the first frequency-domain resource unit group, the size of the active BWP, and a first higher layer parameter.

Optionally, in embodiments of the disclosure, the first indication information indicates an index of a 1^{st} first frequency-domain resource unit allocated to the terminal device 100 and the number of first frequency-domain resource units.

Optionally, in embodiments of the disclosure, the first indication information includes an RIV, and the number of bits of the RIV and/or a value of the RIV is determined based on the number of first frequency-domain resource units in the first frequency-domain resource unit group.

Optionally, in embodiments of the disclosure, the first frequency-domain resource unit is an RE, an RB, an RBG, or a subband.

The terminal device 100 in embodiments of the disclosure can implement corresponding functions of the terminal device in the foregoing method embodiments. For the procedure, function, implementation, and advantage corresponding to each module (sub-module, unit, or assembly, etc.) in the terminal device 100, reference can be made to the corresponding illustrations in the foregoing method embodiments, which will not be described in detail again herein. It should be noted that, the functions of various modules (sub-modules, units, or assemblies, etc.) in the terminal device 100 described in embodiments of the disclosure may be implemented by different modules (sub-modules, units, or assemblies, etc.), or may be implemented by the same module (sub-module, unit, or assembly, etc.). For example, the first transmitting module and the second transmitting module may be different modules or may be the same module, both of which can implement the corresponding functions thereof in embodiments of the disclosure. In addition, the communication module in embodiments of the disclosure may be implemented by a transceiver of a device, and some or all of the other modules may be implemented by a processor of the device.

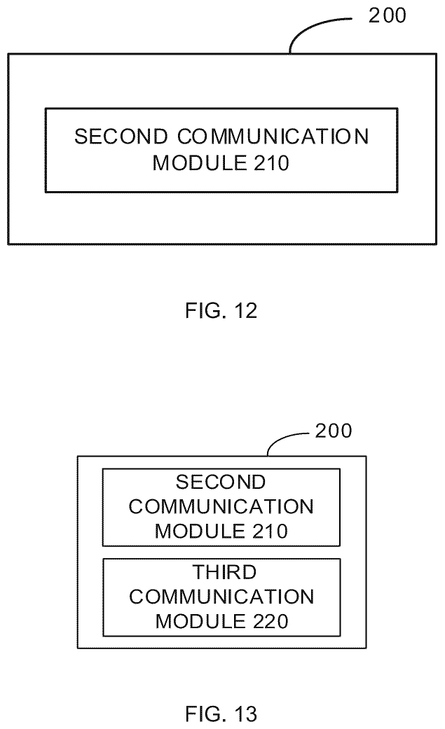

FIG. 12 is a schematic block diagram of a network device 200 according to an embodiment of the disclosure. The network device 200 may include a second communication module 210. The second communication module 210 s configured to send first indication information to a terminal device, where the first indication information indicates at least one first frequency-domain resource unit scheduled for or allocated to the terminal device; the at least one first frequency-domain resource unit belongs to a first frequency-domain resource unit group, and the first frequency-domain resource unit group is in an active BWP of the terminal device.

Optionally, as illustrated in FIG. 13, the network device 200 may further include a third communication module 220. The third communication module 220 is configured to indicate a resource type of the first frequency-domain resource unit group and/or the first frequency-domain resource unit group. In other words, in embodiments of the disclosure, the resource type of the first frequency-domain resource unit group and/or the first frequency-domain resource unit group may be determined based on second indication information sent by the network device 200.

Optionally, in embodiments of the disclosure, the second indication information is carried in higher layer configuration signaling or DCI.

Optionally, in embodiments of the disclosure, the second indication information indicates a resource type of a frequency-domain resource unit in a first time-domain resource.

Optionally, in embodiments of the disclosure, the first time-domain resource includes at least one of: at least one symbol, at least one slot, at least one subslot, at least one UL/DL transmission period, at least one subframe, or at least one frame.

Optionally, in embodiments of the disclosure, the second indication information indicates a resource type of M time-frequency resources, each time-frequency resource in the M time-frequency resources is determined based on a time-domain resource unit and a frequency-domain resource unit corresponding to the time-frequency resource, and M is an integer and M≥1.

Optionally, in embodiments of the disclosure, the second indication information includes M pieces of bit information that are in one-to-one correspondence with the M time-frequency resources, and each bit information in the M pieces of bit information indicates a resource type of a time-frequency resource corresponding to the bit information.

Optionally, in embodiments of the disclosure, the first indication information includes N pieces of bit information, each bit information in the N pieces of bit information corresponds to one first frequency-domain resource unit and indicates whether the first frequency-domain resource unit corresponding to the bit information is allocated to the terminal device, and Nis an integer and N≥1.

Optionally, in embodiments of the disclosure, Nis determined based on at least one of: the number of PRBs in the first frequency-domain resource unit group; an index of a starting PRB of the first frequency-domain resource unit group; or a size of the first frequency-domain resource unit.

Optionally, in embodiments of the disclosure, the size of the first frequency-domain resource unit is determined based on the number of second frequency-domain resource units in the first frequency-domain resource unit.

Optionally, in embodiments of the disclosure, the second frequency-domain resource unit is an RE, an RB, or an RBG.

Optionally, in embodiments of the disclosure, Nis determined at least based on a size of the active BWP, and the size of the active BWP is determined based on the number of PRBs in the active BWP.

Optionally, in embodiments of the disclosure, a size of the first frequency-domain resource unit is determined based on at least one of: a size of the first frequency-domain resource unit group, the size of the active BWP, a first higher layer parameter, or N.

Optionally, in embodiments of the disclosure, a size of the first frequency-domain resource unit is determined based on a size of the first frequency-domain resource unit group and N.

Optionally, in embodiments of the disclosure, the first frequency-domain resource unit is determined based on a size of the first frequency-domain resource unit group, the size of the active BWP, and a first higher layer parameter.

Optionally, in embodiments of the disclosure, the first indication information indicates an index of a 1^{st} first frequency-domain resource unit allocated to the terminal device and the number of first frequency-domain resource units.

Optionally, in embodiments of the disclosure, the first indication information includes an RIV, and the number of bits of the RIV and/or a value of the RIV is determined according to the number of first frequency-domain resource units in the first frequency-domain resource unit group.

Optionally, in embodiments of the disclosure, the first frequency-domain resource unit is an RE, an RB, an RBG, or a subband.

The network device 200 in embodiments of the disclosure can implement corresponding functions of the network device in the foregoing method embodiments. For the procedure, function, implementation, and advantage corresponding to each module (sub-module, unit, or assembly, etc.) in the network device 200, reference can be made to the corresponding illustrations in the foregoing method embodiments, which will not be described in detail again herein. It should be noted that, the functions of various modules (sub-modules, units, or assemblies, etc.) in the network device 200 described in embodiments of the disclosure may be implemented by different modules (sub-modules, units, or assemblies, etc.), or may be implemented by the same module (sub-module, unit, or assembly, etc.). For example, the first transmitting module and the second transmitting module may be different modules or may be the same module, both of which can implement the corresponding functions thereof in embodiments of the disclosure. In addition, the communication module in embodiments of the disclosure may be implemented by a transceiver of a device, and some or all of the other modules may be implemented by a processor of the device.

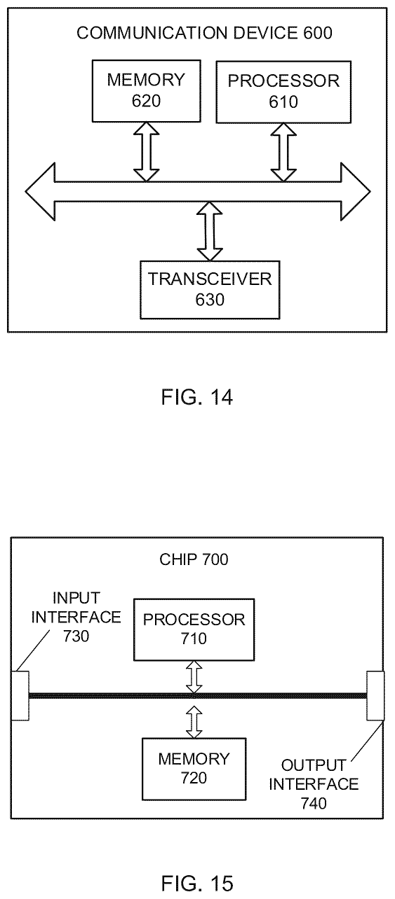

FIG. 14 is a schematic structural diagram of a communication device 600 according to embodiments of the disclosure. The communication device 600 includes a processor 610. The processor 610 can invoke and execute computer programs stored in a memory, to implement the method in embodiments of the disclosure.

Optionally, the communication device 600 may further include a memory 620, where the processor 610 can invoke and execute computer programs from the memory 620 to implement the method in embodiments of the disclosure.

The memory 620 may be a separate device independent of the processor 610, or may be integrated into the processor 610.

Optionally, the communication device 600 may further include a transceiver 630. The processor 610 can control the transceiver 630 to communicate with other devices, and specifically, can send information or data to other devices or receive information or data sent by other devices.

The transceiver 630 may include a transmitter and a receiver. The transceiver 630 may further include an antenna, where one or more antennas may be provided.

Optionally, the communication device 600 may be the network device in embodiments of the disclosure, and the communication device 600 may implement corresponding processes implemented by the network device in various methods according to embodiments of the disclosure, which will not be described again herein for the sake of brevity.

Optionally, the communication device 600 may be the terminal device in embodiments of the disclosure, and the communication device 600 may implement corresponding processes implemented by the terminal device in various methods according to embodiments of the disclosure, which will not be described again herein for the sake of brevity.

FIG. 15 is a schematic structural diagram of a chip 700 according to embodiments of the disclosure. The chip 700 includes a processor 710. The processor 710 can invoke and execute computer programs from a memory, so as to implement the method in embodiments of the disclosure.

Optionally, the chip 700 may further include a memory 720. The processor 710 can invoke and execute computer programs from the memory 720 to implement the method in embodiments of the disclosure.

The memory 720 may be a separate device independent of the processor 710, or may be integrated into the processor 710.

Optionally, the chip 700 may further include an input interface 730. The processor 710 can control the input interface 730 to communicate with other devices or chips, and specifically, can obtain information or data sent by other devices or chips.

Optionally, the chip 700 may further include an output interface 740. The processor 710 may control the output interface 740 to communicate with other devices or chips, and specifically, may output information or data to other devices or chips.

Optionally, the chip may be applied to the network device in embodiments of the disclosure, and the chip may implement a corresponding process implemented by the network device in various methods in embodiments of the disclosure, which will not be described again herein for the sake of brevity.

Optionally, the chip may be applied to the terminal device in embodiments of the disclosure, and the chip may implement a corresponding process implemented by the terminal device in various methods in embodiments of the disclosure, which will not be described again herein for the sake of brevity.

It should be understood that, the chip in embodiments of the disclosure may also be referred to as a system-on-chip (SOC).

The processor may be a general-purpose processor, a digital signal processor (DSP), a field programmable gate array (FPGA), an application specific integrated circuit (ASIC), or other programmable logic devices, transistor logic devices, discrete hardware components, etc. The general-purpose processor may be a microprocessor or any conventional processor.

The memory may be a volatile memory or a non-volatile memory, or may include both a volatile memory and a non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM).

It should be understood that, the memory above is intended for illustration rather than limitation. For example, the memory in embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), and a synch link DRAM (SDRAM), and a direct rambus RAM (DR RAM), etc. That is, the memory in embodiments of the disclosure is intended to include, but not limited to, these and any other suitable types of memory.

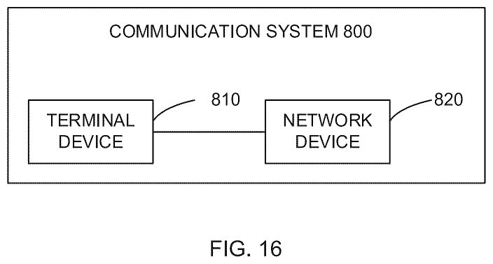

FIG. 16 is a schematic block diagram of a communication system 800 according to embodiments of the disclosure. The communication system 800 includes a terminal device 810 and a network device 820.

The network device 820 sends first indication information to the terminal device 810, where the first indication information indicates at least one first frequency-domain resource unit scheduled for or allocated to the terminal device.

The terminal device 810 receives the first indication information.

The at least one first frequency-domain resource unit belongs to a first frequency-domain resource unit group, and the first frequency-domain resource unit group is in an active BWP of the terminal device.

The terminal device 810 may be configured to implement corresponding functions implemented by the terminal device in the methods of various embodiments of the disclosure, and the network device 820 may be configured to implement corresponding functions implemented by the network device in the methods of various embodiments of the disclosure, which will not be described in detail again herein for the sake of brevity.

All or some of the above embodiments can be implemented through software, hardware, firmware, or any other combination thereof. When implemented by software, all or some the above embodiments can be implemented in the form of a computer program product. The computer program product includes one or more computer instructions. When the computer instructions are applied and executed on a computer, all or some the operations or functions of the embodiments of the disclosure are performed. The computer can be a general-purpose computer, a special-purpose computer, a computer network, or other programmable apparatuses. The computer instruction can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium (such as a digital video disc (DVD)), or a semiconductor medium (such as a solid state disk (SSD)), etc.

It should be understood that, in various embodiments of the disclosure, the magnitude of a sequence number of each of the foregoing processes does not imply an execution order, and the execution order between the processes should be determined according to function and internal logic thereof, which shall not constitute any limitation to the implementation of embodiments of the disclosure.

It will be evident to those skilled in the art that, for the sake of convenience and brevity, in terms of the specific working processes of the foregoing systems, apparatuses, and units, reference can be made to the corresponding processes in the foregoing method embodiments, which will not be described in detail again herein.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

I/We claim:

1. A method for resource indication, comprising:
receiving, by a terminal device, first indication information sent by a network device, wherein the first indication information indicates at least one first frequency-domain resource unit scheduled for or allocated to the terminal device; and
wherein the at least one first frequency-domain resource unit belongs to a first frequency-domain resource unit group, and the first frequency-domain resource unit group is in an active bandwidth part (BWP) of the terminal device.

2. The method of claim 1, wherein a resource type of the first frequency-domain resource unit group and/or the first frequency-domain resource unit group is determined based on second indication information sent by the network device.

3. The method of claim 2, wherein the second indication information indicates a resource type of a frequency-domain resource unit in a first time-domain resource, and the method further comprises:
determining, by the terminal device, the resource type of the first frequency-domain resource unit group in the first time-domain resource or determining the first frequency-domain resource unit group in the first time-domain resource according to a resource type of the first time-domain resource and/or the resource type of the frequency-domain resource unit in the first time-domain resource.

4. The method of claim 3, wherein the first time-domain resource comprises at least one of: at least one symbol, at least one slot, at least one subslot, at least one uplink (UL)/downlink (DL) transmission period, at least one subframe, or at least one frame.

5. The method of claim 2, wherein the second indication information indicates a resource type of M time-frequency resources, each time-frequency resource in the M time-frequency resources is determined based on a time-domain resource unit and a frequency-domain resource unit corresponding to the time-frequency resource, and M is an integer and M≥1; and
wherein the method further comprises:
determining, by the terminal device, the resource type of the first frequency-domain resource unit group or determining the first frequency-domain resource unit group according to the resource type of the M time-frequency resources.

6. The method of claim 1, wherein the first indication information comprises N pieces of bit information, each bit information in the N pieces of bit information corresponds to one first frequency-domain resource unit and indicates whether the first frequency-domain resource unit corresponding to the bit information is allocated to the terminal device, and Nis an integer and N≥1.

7. The method of claim 6, wherein N is determined based on at least one of:
the number of physical resource blocks (PRBs) in the first frequency-domain resource unit group;
an index of a starting PRB of the first frequency-domain resource unit group; or
a size of the first frequency-domain resource unit.

8. The method of claim 7, wherein the size of the first frequency-domain resource unit is determined based on the number of second frequency-domain resource units in the first frequency-domain resource unit.

9. A terminal device, comprising:
a transceiver;
a memory configured to store computer programs; and
a processor configured to invoke and execute the computer programs stored in the memory to:
cause the transceiver to receive first indication information sent by a network device, wherein the first indication information indicates at least one first frequency-domain resource unit scheduled for or allocated to the terminal device; and
wherein the at least one first frequency-domain resource unit belongs to a first frequency-domain resource unit group, and the first frequency-domain resource unit group is in an active bandwidth part (BWP) of the terminal device.

10. The terminal device of claim 9, wherein a resource type of the first frequency-domain resource unit group and/or the first frequency-domain resource unit group is determined based on second indication information sent by the network device.

11. The terminal device of claim 10, wherein the second indication information indicates a resource type of a frequency-domain resource unit in a first time-domain resource, and the processor is configured to:
determine the resource type of the first frequency-domain resource unit group in the first time-domain resource or determine the first frequency-domain resource unit group in the first time-domain resource according to a resource type of the first time-domain resource and/or the resource type of the frequency-domain resource unit in the first time-domain resource.

12. The terminal device of claim 11, wherein the first time-domain resource comprises at least one of: at least one symbol, at least one slot, at least one subslot, at least one uplink (UL)/downlink (DL) transmission period, at least one subframe, or at least one frame.

13. A network device, comprising:
a transceiver;
a memory configured to store computer programs; and
a processor configured to invoke and execute the computer programs stored in the memory to:
cause the transceiver to send first indication information to a terminal device, wherein the first indication information indicates at least one first frequency-domain resource unit scheduled for or allocated to the terminal device;
wherein the at least one first frequency-domain resource unit belongs to a first frequency-domain resource unit group, and the first frequency-domain resource unit group is in an active bandwidth part (BWP) of the terminal device.

14. The network device of claim 13, wherein the transceiver is further configured to:
send second indication information to the terminal device, wherein the second indication information indicates a resource type of the first frequency-domain resource unit group and/or the first frequency-domain resource unit group.

15. The network device of claim 14, wherein the second indication information indicates a resource type of a frequency-domain resource unit in a first time-domain resource.

16. The network device of claim 13, wherein the first indication information comprises N pieces of bit information, each bit information in the N pieces of bit information corresponds to one first frequency-domain resource unit and indicates whether the first frequency-domain resource unit corresponding to the bit information is allocated to the terminal device, and Nis an integer and N≥1.

17. The network device of claim 16, wherein Nis determined at least based on a size of the active BWP, and the size of the active BWP is determined based on the number of PRBs in the active BWP.

18. The network device of claim 17, wherein a size of the first frequency-domain resource unit is determined based on at least one of: a size of the first frequency-domain resource unit group, the size of the active BWP, a first higher layer parameter, or N.

19. The network device of claim 17, wherein a size of the first frequency-domain resource unit is determined based on a size of the first frequency-domain resource unit group and N.

20. The network device of claim 17, wherein a size of the first frequency-domain resource unit is determined based on a size of the first frequency-domain resource unit group, the size of the active BWP, and a first higher layer parameter.
